(19) United States
(12) Patent Application Publication
(10) Pub. No.: US 2012/0056960 A1
(43) Pub. Date: Mar. 8, 2012

(54) Two-Piece Hinged Housing and Frame for a Printer

(75) Inventor: Larri B. Williams, Dayton, OH (US)

(73) Assignee: AVERY DENNISON CORPORATION, Pasadena, CA (US)

(21) Appl. No.: 13/196,634

(22) Filed: Aug. 2, 2011

Related U.S. Application Data
(60) Provisional application No. 61/370,058, filed on Aug. 2, 2010.

(51) Int. Cl. B41J 29/13

(52) U.S. Cl. 347/108

(57) ABSTRACT

The present invention discloses a two piece hinged housing and frame for a printer. The two housing members are pivotally hinged together. The first housing member is statically attached to the frame and the base of the printer while the second housing member can be fully removed from the printer.

### CROSS-REFERENCE TO RELATED APPLICATION

The present application claims the benefit of U.S. Provisional Application No. 61/370,058 filed Aug. 2, 2010, which is incorporated herein by reference in its entirety.

### BACKGROUND OF THE INVENTION

The present inventive subject matter relates generally to the art of printers. Particular relevance is found in connection with tabletop thermal printers, and accordingly the present specification makes specific reference thereto. However, it is to be appreciated that aspects of the present inventive subject matter are also equally amenable to other like applications.

Printers are commonly provisioned with an external housing to protect and/or otherwise cover the internal works of the printer. Such a housing may be at least partially secured to a frame which provides a degree of support and/or rigidity to the housing. In any event, it can be desirable to access internal spaces within the outer housing, e.g., to load print media or ink ribbons, adjust internal settings, etc. However, completely removing an external housing from the frame can be cumbersome and/or time consuming. Accordingly, it is often desirable to have a housing suitable for selectively providing access to internal spaces within the housing without entirely removing the housing from the frame. However, it can be difficult to provide sufficient support for and/or rigidity to the housing when such housings are employed.

U.S. Pat. No. 5,947,618 to Keller, et al. is incorporated herein by reference in its entirety and discloses a printer having a housing with a selectively openable cover mounted thereto via a hinge.

A new and/or improved two piece hinged housing and frame for a printer are disclosed which address the above-referenced problem(s) and/or others.

### SUMMARY OF THE INVENTION

In accordance with one embodiment, a printer housing as essentially described herein is provided.

Numerous advantages and benefits of the inventive subject matter disclosed herein will become apparent to those of ordinary skill in the art upon reading and understanding the present specification.

### BRIEF DESCRIPTION OF THE DRAWING(S)

The inventive subject matter disclosed herein may take form in various components and arrangements of components, and in various steps and arrangements of steps. The drawings are only for purposes of illustrating preferred embodiments and are not to be construed as limiting. Further, it is to be appreciated that the drawings may not be to scale.

FIG. 1 is a diagrammatic illustration of a tabletop thermal printer in accordance with aspects of the present inventive subject matter.

FIG. 2 shows the printer of FIG. 1 having an outer housing opened to reveal internal components of the printer.

FIG. 3 is another view, similar to FIG. 2, showing the printer with various components removed therefrom to more fully show a frame and the outer housing of the printer.

FIG. 4 is partially exploded view of FIG. 3.

### DETAILED DESCRIPTION OF THE EMBODIMENT(S)

For clarity and simplicity, the present specification shall refer to structural and/or functional elements, relevant standards and/or protocols, and other components that are commonly known in the art without further detailed explanation as to their configuration or operation except to the extent they have been modified or altered in accordance with and/or to accommodate the preferred embodiment(s) presented herein.

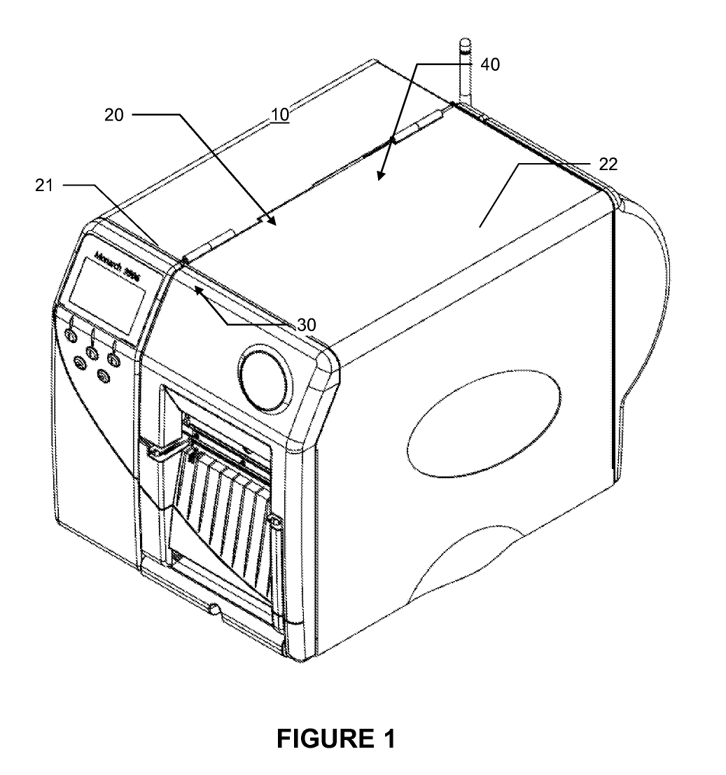

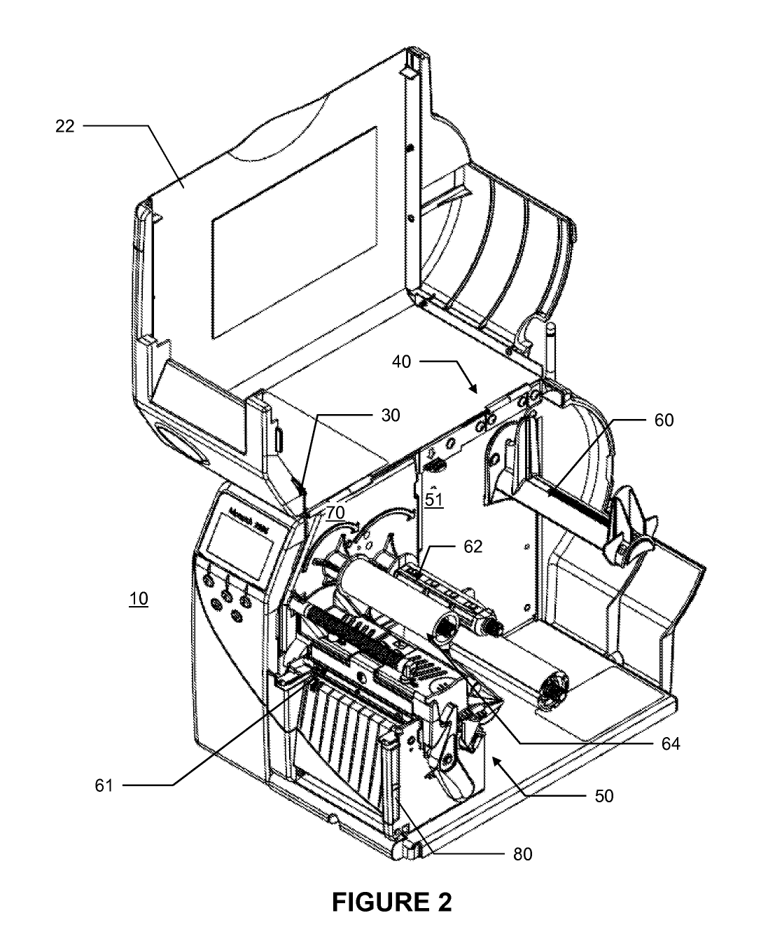

With reference now to FIGS. 1 and 2, there is shown a tabletop thermal printer generally indicated at 10 having a two piece housing 20, including a first housing member 21 and a second housing member 22 pivotally joined together at hinges 30 and 40. While FIGS. 1 and 2 contemplate the utilization of a two piece housing, it is contemplated that the housing may comprise a plurality of pieces that are pivotally joined to one another. For example, the housing the present invention in one embodiment may comprise a first, second and third housing members that are pivotally joined to one another at a first, second and third hinge respectively.

The printer 10 also includes a frame 50 to which the housing 20 is mounted. A roll of label stock or other suitable print media (not shown) is held by the media supply roll mounting assembly 60 mounted on a vertical wall 51 of the frame 50. For example, the label stock may include a series of individual labels or record members releasably adhered via a pressure sensitive adhesive or the like to a release liner or similar continuous web of material. In any event, the print media is supplied from the roll held by the media supply roll mounting assembly 60 to a thermal printhead (not shown) for marking thereby. In the illustrated embodiment, the printhead is supported in a printhead assembly 61 mounted in cantilevered fashion to a selectively pivotal mounting member 70 that is secured to the vertical wall 51 of the frame 50.

FIG. 2 also shows: an ink ribbon supply spindle 62 for holding a roll of thermal ink ribbon (not shown) from which the ribbon is supplied to the printhead of the printhead assembly 61; and, an ink ribbon take-up spindle 64 for receiving and holding a roll of the spent or used ink ribbon. The spindles 62 and 64 are also mounted in a cantilevered fashion to the selectively pivotable mounting member 70. As shown, the selectively pivotable mounting member 70 is positioned upright or vertically, i.e., in the operating position. To facilitate loading and/or threading of the print media and/or ink ribbon between the printhead and a cooperating platen roller (not shown) rotatably mounted in a support bracket 80, the mounting member 70 is selectively tilted back from the upright position thereby raising the cantilevered printhead assembly 61 away from the platen roller.

As can be appreciated, suitably the print media is routed and/or guided along a path from the roll carried by the media supply roll mounting assembly 60 to the printhead assembly 61 where it passes (along with an optional ink ribbon from the ink ribbon supply spindle 62) between the thermal printhead of the printhead assembly 61 and the cooperating platen roller supported on the bracket 80.

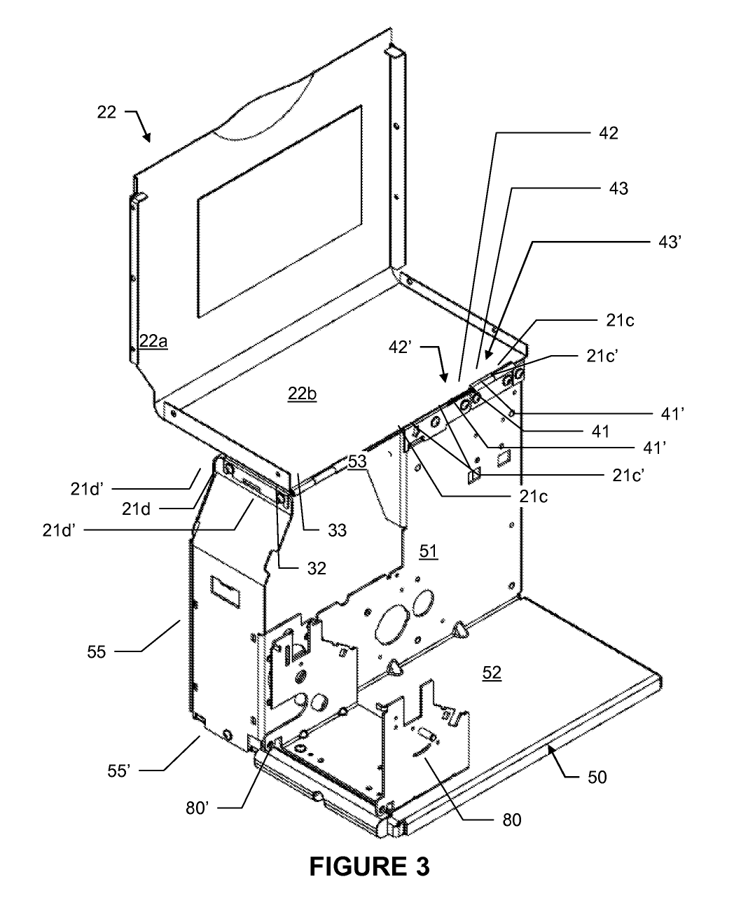

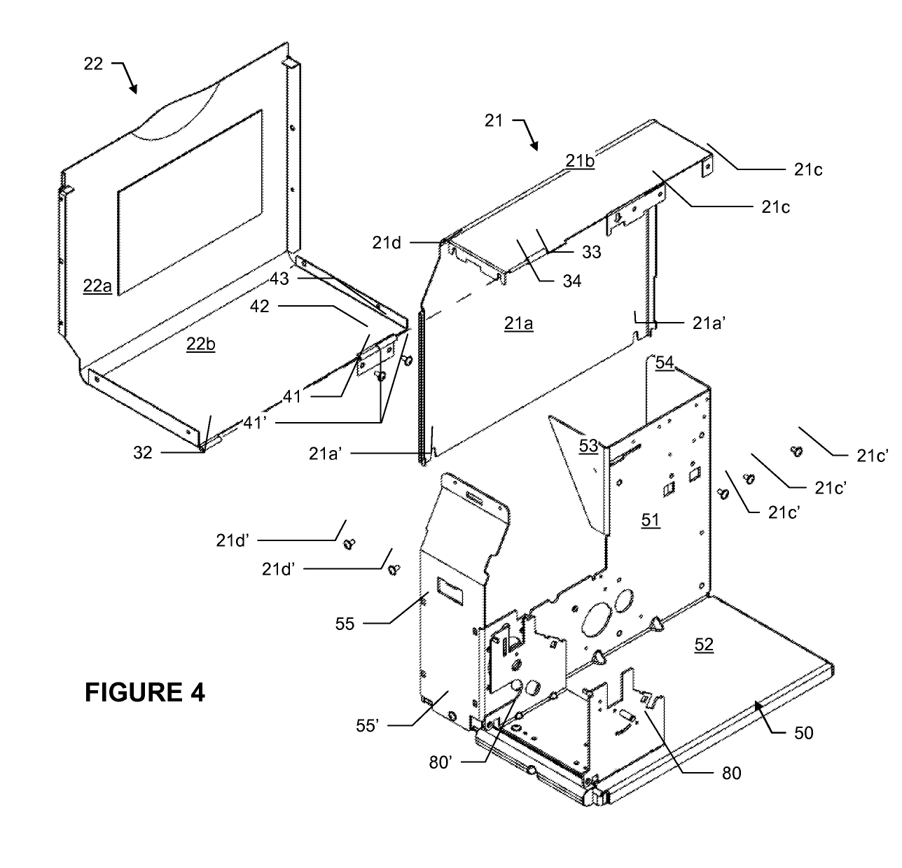

With reference now to FIGS. 3 and 4, the frame 50 is suitably formed from a unitary piece of material, e.g., sheet metal. The frame 50 includes a horizontally extending floor plate 52 which overlies and is secured to a base (not shown), e.g., with screws or other suitable fasteners. The vertically extending wall 51 of the frame 50 suitably forms a right angle with respect to the floor plate 52. As shown the wall 51 includes a front relatively shorter portion where the selectively pivotal mounting member 70 is secured, and a rear relatively taller portion including angled flanges 53 and 54. The bracket 80 is suitably secured to the floor plate 52 via more or more screws 80′ alongside the relatively lower portion of the wall 51.

The frame 50 also includes a substantially vertical integral front wall 55. As shown, the wall 55 includes a substantially vertical lower portion, an inclined middle portion and a substantially vertical top mounting area. Suitably, the front wall 55 is substantially as tall as the rear portion of wall 51. As shown, a screw 55′ secures a bottom of the front wall 55 to the base.

The first housing member 21 is generally L-shaped and includes a vertically extending sidewall 21a and a horizontally extending top plate 21b. Toward the rear of the top plate 21b, the first housing member 21 includes downward depending tabs or flanges 21c that are used to secure the first housing member 21 to the wall 51 of the frame 50, e.g., via screws 21c′ or other suitable fasteners. When so connected, suitably, the top plate 21b of the housing member 21 rests on and/or is supported by the angled flanges 53 and 54. Towards a front of the top plate 21b, there is another downward depending tab or flange 21d that is used to further secure the first housing member 21 to the front wall 55 of the frame 50, e.g., via screws 21d′ or other suitable fasteners.

Along a bottom edge of the sidewall 21a, there are formed a plurality of slots 21a′ through which screws or other suitable fasteners may pass to secure the first housing member 21 to the base of the printer 10.

In the foregoing manner, the first housing member 21 is statically or non-movingly affixed to the frame 50 and the base of the printer 10. The second housing member 22 is pivotally joined to the frame 50 and the first housing member 21 via hinges 30 and 40. In particular, the first hinge 30 is a free floating hinge (i.e., it is not directly secured to the frame 50) which joins the first and second housing members 21 and 22 to one another. The second hinge 40 includes a hinge plate 41 which is secured to the wall 51 of the frame 50, e.g., via screws 41′, and thereby joins the second housing member 22 to the frame 50.

More specifically, the second housing member 22 is also generally L-shaped and includes a sidewall 22a and top plate 22b which are substantially orthogonal to one another. Towards a rear end of the top plate 22b, the member 22 has an integrally formed knuckle 42 which acts as part of the hinge 40. Suitably, the hinge plate 41 has a corresponding second knuckle 43 integrally formed at a top edge thereof. The first and second knuckles 42 and 43 are aligned and a pin (not shown) is inserted therethrough to complete the hinge 40. In practice, the free or open ends 42′ and 43′ of the knuckles 42 and 43 are suitably crimped to retain the pin therein while allowing one or both of the knuckles 42 and 43 to freely rotate about the captured pin.

Towards a front end of the top plate 22b, the member 22 has another integrally formed knuckle 32 which acts as part of the hinge 30. Suitably, the top plate 21b of the first housing member 21 also has a corresponding second knuckle 33 integrally formed towards a front end thereof. The first and second knuckles 32 and 33 are aligned and a pin 34 is inserted therethrough to complete the hinge 30. In practice, the knuckle 33 is suitably crimped around the pin 34 to fixedly retain the pin 34 therein while allowing the knuckle 32 to freely rotate about the captured pin 34.

As can be appreciated, if desired, the second housing member 22 can be removed fully from the printer 10 by detaching the hinge 40 from the frame 50 (i.e., by unscrewing the screws 41′), and sliding the knuckle 32 off the pin 34.

In any event, it is to be appreciated that in connection with the particular exemplary embodiment(s) presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A hinged housing for a printer containing at least a first and a second housing member pivotally joined together.

2. The housing of claim 1 wherein the housing is joined to a frame.

3. The housing of claim 2 wherein the housing and frame are connected to a printer.

4. The housing of claim 1 wherein the first housing member is generally L-shaped.

5. The housing of claim 1 wherein the first housing member includes a vertically extending sidewall and a horizontally extending top plate.

6. The housing of claim 2 wherein the first housing member is secured to the frame by downward depending tabs or flanges on the first housing member.

7. The housing of claim 3 wherein the first housing member is statically or non-movingly affixed to the frame and base of the printer.

8. The housing of claim 1 wherein the second housing member is pivotally joined to the frame through a hinge.

9. The housing of claim 8 wherein the second housing member is generally L-shaped.

10. The housing of claim 8 wherein the second housing member includes a sidewall and a top plate which are substantially orthogonal to each other.

11. The housing of claim 8 wherein the hinge includes a hinge plate.

12. The housing of claim 11 wherein the second member has an integrally formed first knuckle and the hinge plate has a corresponding second knuckle.

13. The housing of claim 12 wherein the first and second knuckles are aligned and a pin is inserted through to create the hinge in which the knuckles freely rotate about the captured pin.

14. The housing of claim 1 wherein the second member has an integrally formed first knuckle and the second member has a corresponding second knuckle.

15. The housing of claim 14 wherein the first and second knuckles are aligned and a pin is inserted through to create the hinge.

16. The housing of claim 15 wherein the first knuckle can freely rotate about the pin.

17. The housing of claim 3 wherein the second housing member is fully removable from the printer.

18. A printer comprising:
a frame having a wall;
a housing mounted on the frame wherein the housing has a first and second housing member wherein the first and second housing member are joined together at a first and a second hinge; and
a roll of print media attached to a mounting assembly on the wall of the frame.
